(19) United States
(12) Patent Application Publication
(10) Pub. No.: US 2017/0260479 A1
(43) Pub. Date: Sep. 14, 2017

(54) FABRIC CARE COMPOSITIONS COMPRISING EMULSIONS

(71) Applicant: Dow Corning Corporation, Midland, MI (US)

(72) Inventors: Thomas Daniel BEKEMEIER, Birch Run, MI (US); Samuel COSTANZO, Midland, MI (US); Kathelyne EVERAERE, Waterloo (BE); Donald Taylor LILES, Midland, MI (US); Martin Kent SEVERANCE, Midland, MI (US); Jonathan THILL, Pont-a-celles (BE); Heidi Marie VANDORT, Sanford, MI (US); Brett Lee ZIMMERMAN, Frankenmuth, MI (US)

(21) Appl. No.: 15/522,589

(22) PCT Filed: Nov. 21, 2013
(86) PCT No.: PCT/US2013/071278

§ 371 Date: Apr. 27, 2017

Related U.S. Application Data
(60) Provisional application No. 61/729,024, filed on Nov. 21, 2012.

(51) Int. Cl. C11D 3/00; C11D 3/37; C11D 1/66; C11D 3/18; C11D 17/06; C11D 1/22; C11D 17/00; C11D 11/00

(52) U.S. Cl. CPC C11D 3/001; C11D 17/0017; C11D 3/373; C11D 11/0017; C11D 3/18; C11D 17/06; C11D 17/0047; C11D 17/0043; C11D 17/003; C11D 17/0008; C11D 1/22; C11D 1/66

(57) ABSTRACT

Fabric care compositions comprising bi-modal water continuous emulsions are disclosed. In particular, the fabric care compositions comprise a bi-modal water continuous emulsion (E) comprising at least 70 weight percent of: a first dispersed phase containing a hydrophobic oil, wherein the hydrophobic oil is provided as a non-emulsified hydrophobic oil, and a second dispersed phase containing a silicone, wherein the silicone is provided from a water continuous silicone emulsion containing at least one surfactant. The fabric care compositions further comprise at least one fabric care ingredient (F). Optionally, the fabric care ingredient (F) is in an acceptable medium. Preparation methods and uses of the fabric care compositions are also disclosed.

### CROSS-REFERENCE TO RELATED APPLICATIONS

This application claims priority to and all the advantages of U.S. Provisional Patent Application No. 61/729,024, filed on Nov. 21, 2012, the content of which is incorporated herein by reference.

### TECHNICAL FIELD

This disclosure relates to fabric care compositions comprising an emulsion (E), and at least one fabric care ingredient (F), in an acceptable medium.

### BACKGROUND

Emulsions are a useful means compatibilising initially incompatible materials. Simple emulsions are usually at least composed of an external, continuous phase and an internal, dispersed phase and at least one surface active agent used to compatibilise the distinct phases. Emulsions of various ingredients may be used in fabric care applications, where they allow incorporation of incompatible materials in a larger matrix such as conditioning polymers in a fabric softener.

There is a continuous need to provide for emulsions which lower the environmental impact of transport, by reducing the amount of water contained in the emulsion. There is a continuous need to provide for emulsions which are not detrimental to the health of consumers by reducing the amount of surfactant contained in the emulsion or by reducing the amount of biocide.

There is a continuous need to simplify the formulator's work by providing for emulsions which are easy to use, pourable, while at the same time containing a limited amount of unnecessary ingredients which allow larger latitude for useful ingredients. That is, limiting the amount of water to allow incorporation of more active ingredients such as dyes, care agents and the like.

There is an ongoing need for emulsions of conditioning polymers which provide for care of fabric substrates and fibres.

### BRIEF SUMMARY OF THE INVENTION

The present invention relates to fabric care compositions comprising bi-modal water continuous emulsions. In particular, the present disclosure relates to fabric care compositions comprising a bi-modal water continuous emulsion (E) comprising at least 70 weight percent of: a first dispersed phase containing a hydrophobic oil, wherein the hydrophobic oil is provided as a non-emulsified hydrophobic oil, a second dispersed phase containing a silicone, wherein the silicone is provided from a water continuous silicone emulsion containing at least one surfactant; and at least one fabric care ingredient (F), in an acceptable medium.

The invention also relates to a process to prepare the fabric care compositions and uses of said fabric care compositions.

### DETAILED DESCRIPTION OF THE INVENTION

The present invention relates to fabric care compositions comprising emulsions. In particular, the present disclosure relates to fabric care compositions comprising a bi-modal water continuous emulsion (E) comprising at least 70 weight percent of: a first dispersed phase containing a hydrophobic oil, wherein the hydrophobic oil is provided as a non-emulsified hydrophobic oil, a second dispersed phase containing a silicone, wherein the silicone is provided from a water continuous silicone emulsion containing at least one surfactant; and at least one fabric care ingredient (F), in an acceptable medium.

The present bi-modal emulsions (E) are water continuous emulsions having two distinct dispersed phases. As used herein, “dispersed phase” refers to the water insoluble particles suspended in the continuous aqueous phase of the emulsion. The first dispersed phase contains a hydrophobic oil, which may be either an organic oil or a silicone. The independent second dispersed phase contains a silicone that is provided from a previously formed water continuous emulsion. Each dispersed phase may be characterized by its own average particle size distribution in the emulsion, in other words, the average particle size of the two independent dispersed phases demonstrate a “bi-modal” distribution.

### The First Dispersed Phase of Bi-Modal Emulsion (E)

The bi-modal emulsions contain a first dispersed phase containing a hydrophobic oil (designated herein as component (A)). The hydrophobic oil (A) in the first dispersed phase of the present bi-modal emulsion has not been pre-emulsified. In other words, the hydrophobic oils in the first dispersed phase are derived from neat or non-emulsified hydrophobic oils. The hydrophobic oil (A) may be selected from a) an organic oil, b) a silicone, or any mixtures or combinations thereof.

When the hydrophobic oil phase is considered to be an organic oil phase, it means the majority of this dispersed phase comprises organic compounds or organic polymers. The organic oil may be selected from hydrocarbons, esters, oils derived from natural fats or oils, organic polymers, or mixtures thereof.

Examples of suitable organic oil components include natural oils such as coconut oil; hydrocarbons such as mineral oil, paraffins and hydrogenated polyisobutene; fatty alcohols such as octyldodecanol; esters such as C12-C15 alkyl benzoate; diesters such as propylene dipelarganate; and triesters, such as glyceryl trioctanoate.

Examples of esters as suitable organic oil may have the structure QCO-OQ′ wherein QCO represents the carboxylic acid radical and wherein OQ′ is an alcohol residue. Examples of these esters include isotridecyl isononanoate, PEG-4 diheptanoate, isostearyl neopentanoate, tridecyl neopentanoate, cetyl octanoate, cetyl palmitate, cetyl ricinoleate, cetyl stearate, cetyl myristate, coco-dicaprylate/caprate, decyl isostearate, isodecyl oleate, isodecyl neopentanoate, isohexyl neopentanoate, octyl palmitate, dioctyl malate, tridecyl octanoate, myristyl myristate, octododecanol, or mixtures of octyldodecanol, acetylated lanolin alcohol, cetyl acetate, isododecanol, polyglyceryl-3-diisostearate, or mixtures thereof.

Examples of natural oils include castor oil, lanolin and lanolin derivatives, triisocetyl citrate, sorbitan sesquioleate, C10-18 triglycerides, caprylic/capric/triglycerides, coconut oil, corn oil, cottonseed oil, glyceryl triacetyl hydroxystearate, glyceryl triacetyl ricinoleate, glyceryl trioctanoate, hydrogenated castor oil, linseed oil, mink oil, olive oil, palm oil, castor oil, illipe butter, rapeseed oil, soybean oil, sunflower seed oil, pine oil, tallow, tricaprin, trihydroxystearin, triisostearin, trilaurin, trilinolein, trimyristin, triolein, tripalmitin, tristearin, walnut oil, wheat germ oil, cholesterol, or mixtures thereof.

The organic oil may further contain an organic polymer such as polybutenes or polyisobutylenes, polyacrylates, polystyrenes, polybutadienes, polyamides, polyesters, polyacrylates, polyurethanes, polysulfones, polysulfides, epoxy functional polymers, as well as copolymers or terpolymers containing these organic polymers, and mixtures of any of these.

Further suitable organic oils may be solid at room temperature, such as organic butters and organic waxes.

Examples of butters include shea butter, mango butter.

Examples of organic waxes include those selected from synthetic and natural origin such as mineral waxes, animal waxes, vegetal waxes, hydrogenated oils, fatty esters and glycerides which are solid at 25° C.

Examples of organic waxes include esters derived from a monovalent saturated C16-C60 alkanol and a saturated C8-C36 monocarboxylic acid, glycerol triesters of saturated linear C18-C40 carboxylic acids, candelilla wax, carnauba wax, beeswax, saturated linear C16-C18, C20, and C22-C40 carboxylic acids, hardened castor oil, ozokerite, polyethylene wax, microcrystalline wax, ceresin, lanolin wax, rice bran wax, montan wax, orange wax, lemon wax and paraffin wax.

The hydrophobic oil (A) may be selected from various silicone polymers. In this embodiment, the hydrophobic oil phase is considered to be a silicone oil phase, which means the majority of this dispersed phase comprises silicone polymers. As used herein, “silicone composition” refers to a composition containing at least one organopolysiloxane.

Organopolysiloxanes are polymers containing siloxy units independently selected from (R₃SiO_{1/2}), (R₂SiO_{2/2}), (RSiO_{3/2}), or (SiO_{4/2}) siloxy units, where R may be any organic group, alternatively R is a hydrocarbon group containing 1 to 30 carbons, alternatively R is an alkyl group containing 1 to 12 carbon atoms, or alternatively R is methyl or phenyl. These siloxy units are commonly referred to as M, D, T, and Q units respectively. Their molecular structures are listed below:

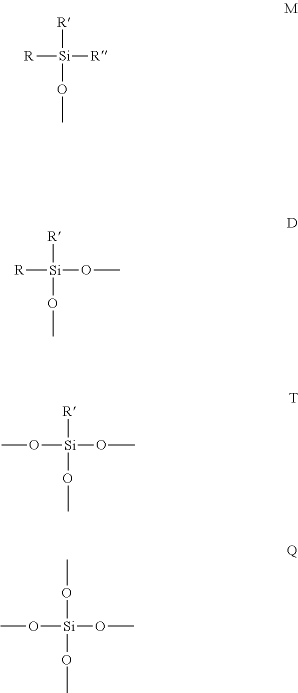

These siloxy units can be combined in various manners to form cyclic, linear, or branched structures. The chemical and physical properties of the resulting polymeric structures vary depending on the number and type of siloxy units in the organopolysiloxane.

The silicone composition may contain a single organopolysiloxane, or mixture of various organopolysiloxanes. In some instances, the mixture of organopolysiloxanes can react with each other to form higher molecular weight organopolysiloxanes. Such reactions are exemplified by condensation or hydrosilylation reactions.

The silicone composition may contain silicone fluids, silicone gums, silicone rubbers, silicone elastomers, silicone resins, silicone waxes, saccharide-siloxane polymer, vinyl polymer grafted with a carbosiloxane dendrimers or any combinations thereof.

The organopolysiloxane may be a trimethylsiloxy or hydroxy (SiOH) terminated polydimethylsiloxane. Trimethylsiloxy end blocked polydimethysiloxanes have the formula Me₃SiO(Me₂SiO_{2/2})_{dp}SiMe₃ wherein the degree of polymerization (dp) is greater than 1, or alternatively the dp is sufficient to provide a kinematic viscosity that may range from 1 to 1,000,000 mm²/s (10⁻⁶ m²/s) at 25° C., or alternatively from 100 to 600,000 mm²/s (10⁻⁶ m²/s) at 25° C., or alternatively from 1000 to 600,000 mm²/s (10⁻⁶ m²/s) at 25° C.

When the silicone composition contains organopolysiloxanes components that can react via hydrosilylation, the silicone component contains:

b¹) an organopolysiloxane having at least two silicon-bonded alkenyl groups per molecule,
b²) an organohydrogensiloxane having at least two SiH groups per molecule, and
b³) a hydrosilylation catalyst.

The organopolysiloxane having at least two silicon-bonded alkenyl groups per molecule b¹) comprises at least two siloxy units represented by the formula

R²RₘSiO_{(4-1-m)/2}

wherein R is an hydrocarbon group containing 1 to 30 carbon atoms, R² is an alkenyl group containing 2 to 12 carbon atoms, and m is zero to 2. The R² alkenyl groups of Component b¹) are exemplified by vinyl, allyl, 3-butenyl, 4-pentenyl, 5-hexenyl, 6-heptenyl, 7-octenyl, 8-nonenyl, 9-decenyl, 10-undecenyl, 4,7-octadienyl, 5,8-nonadienyl, 5,9-decadienyl, 6, 11-dodecadienyl and 4,8-nonadienyl.

The R² alkenyl group may be present on any mono, di, or tri siloxy unit in the organopolysiloxane, for example: (R²R₂SiO_{1/2}), (R²RSiO_{2/2}), or (R²SiO_{3/2}); as well as in combination with other siloxy units not containing an R² substituent, such as (R₃SiO_{1/2}), (R₂SiO_{2/2}), (RSiO_{3/2}), or (SiO_{4/2}) siloxy units where R is a hydrocarbon containing 1 to 30 carbons, alternatively an alkyl group containing 1 to 12 carbons, alternatively an alkyl group containing 1 to 6 carbons or alternatively methyl; providing there are at least two R² substituents in the organopolysiloxane. The monovalent hydrocarbon group R having from 1 to 30 carbon atoms is exemplified by alkyl groups such as: methyl, ethyl, propyl, butyl, hexyl, octyl, and decyl; cycloaliphatic groups such as cyclohexyl; aryl groups such as phenyl, tolyl, and xylyl; and aralkyl groups such as benzyl and phenylethyl.

Component b¹) may be selected from trimethylsiloxy-terminated polydimethylsiloxane-polymethylvinylsiloxane copolymers, vinyldimethylsiloxy-terminated polydimethylsiloxane-polymethylvinylsiloxane copolymers, trimethylsiloxy-terminated polydimethylsiloxane-polymethylhexenylsiloxane copolymers, hexenyldimethylsiloxy-terminated polydimethylsiloxane-polymethylhexenylsiloxane copolymers, trimethylsiloxy-terminated polymethylvinylsiloxane polymers, trimethylsiloxy-terminated polymethylhexenylsiloxane polymers, vinyldimethylsiloxy-terminated polydimethylsiloxane polymers, hexenyldimethylsiloxy-terminated polydimethylsiloxane polymers, or any combination thereof, each having a degree of polymerization of from 10 to 300, or alternatively having a viscosity at 25° C. of from 10 to 1000 mPa·s (10⁻³ Pa·s).

Component b²) is an organohydrogensiloxane having an average of greater than two silicon bonded hydrogen atoms per molecule. As used herein, an organohydrogensiloxane is any organopolysiloxane containing a silicon-bonded hydrogen atom (SiH).

Organohydrogensiloxanes are organopolysiloxanes having at least one SiH containing siloxy unit, that is at least one siloxy unit in the organopolysiloxane has the formula (R₂HSiO_{1/2}), (RHSiO_{2/2}), or (HSiO_{3/2}). Thus, the organohydrogensiloxanes useful in the present invention may comprise any number of (R₃SiO_{1/2}), (R₂SiO_{2/2}), (RSiO_{3/2}), (R₂HSiO_{1/2}), (RHSiO_{2/2}), (HSiO_{3/2}) or (SiO_{4/2}) siloxy units, providing there are on average at least two SiH siloxy units in the molecule. Component b²) can be a single linear or branched organohydrogensiloxane or a combination comprising two or more linear or branched organohydrogensiloxanes that differ in at least one of the following properties: structure, viscosity, average molecular weight, siloxane units, and sequence. There are no particular restrictions on the molecular weight of the organohydrogensiloxane, but typically the viscosity of the organohydrogensiloxane at 25° C. is from 3 to 10,000 mPa·s (10⁻³ Pa·s), alternatively 3 to 1,000 mPa·s (10⁻³ Pa·s), or alternatively 10 to 500 mPa·s (10⁻³ Pa·s).

The amount of SiH units present in the organohydrogensiloxane may vary, providing there are at least two SiH units per organohydrogensiloxane molecule. The amount of SiH units present in the organohydrogensiloxane is expressed herein as % SiH which is the weight percent of hydrogen in the organohydrogensiloxane. Typically, the % SiH varies of from 0.01 to 10%, alternatively of from 0.1 to 5%, or alternatively of from 0.5 to 2%.

The organohydrogensiloxane may comprise the average formula;

(R³₃SiO_{1/2})ₐ(R⁴₂SiO_{2/2})_{b}(R⁴HSiO_{2/2})_{c} wherein

R³ is hydrogen or R⁴,
R⁴ is a monovalent hydrocarbon group having from 1 to 10 carbon atoms
a≧2,
b≧0, alternatively b=1 to 500, alternatively b=1 to 200,
c≧2, alternatively c=2 to 200, alternatively c=2 to 100.

R⁴ may be a substituted or unsubstituted aliphatic or aromatic hydrocarbyl. Monovalent unsubstituted aliphatic hydrocarbyls are exemplified by, but not limited to alkyl groups such as methyl, ethyl, propyl, pentyl, octyl, undecyl, and octadecyl and cycloalkyl groups such as cyclohexyl. Monovalent substituted aliphatic hydrocarbyls are exemplified by, but not limited to halogenated alkyl groups such as chloromethyl, 3-chloropropyl, and 3,3,3-trifluoropropyl. The aromatic hydrocarbon group is exemplified by, but not limited to, phenyl, tolyl, xylyl, benzyl, styryl, and 2-phenylethyl.

The amounts of components b¹) and b²) used may vary, but typically the amounts of components b¹) and b²) are selected so as to provide a molar ratio of the alkenyl groups to SiH in the composition that is greater than 1.

Component b³) is a hydrosilylation catalyst. The hydrosilylation catalyst may be any suitable Group VIII metal based catalyst selected from a platinum, rhodium, iridium, palladium or ruthenium. Group VIII group metal containing catalysts useful to catalyze curing of the present compositions can be any of those known to catalyze reactions of silicon bonded hydrogen atoms with silicon bonded unsaturated hydrocarbon groups. The typical Group VIII metal for use as a catalyst to effect cure of the present compositions by hydrosilylation is a platinum based catalyst. Some typical platinum based hydrosilylation catalysts for curing the present composition are platinum metal, platinum compounds and platinum complexes. Suitable platinum catalysts are described in U.S. Pat. No. 2,823,218 (commonly referred to as “Speier's catalyst) and U.S. Pat. No. 3,923,705. The platinum catalyst may be “Karstedt's catalyst”, which is described in Karstedt's U.S. Pat. No. 3,715,334 and U.S. Pat. No. 3,814,730. Karstedt's catalyst is a platinum divinyl tetramethyl disiloxane complex typically containing about one-weight percent of platinum in a solvent such as toluene. Alternatively the platinum catalyst may be a reaction product of chloroplatinic acid and an organosilicon compound containing terminal aliphatic unsaturation, as described in U.S. Pat. No. 3,419,593. Alternatively, the hydrosilylation catalyst is a neutralized complex of platinum chloride and divinyl tetramethyl disiloxane, as described in U.S. Pat. No. 5,175,325.

The amounts of catalyst b³) used may vary, but typically an amount is used to effect the hydrosilylation reaction. When the catalyst is a Pt compound, typically a sufficient amount of the compound is added to provide 2 to 500 ppm of Pt in the silicone composition.

Additional components may be added to the hydrosilylation reaction. For example, heptamethyltrisiloxysilane may be added as an endblocker to control molecular weight of the organopolysiloxane product.

When the silicone composition contains organopolysiloxanes components that can react via condensation, the silicone component comprises an organopolysiloxane having at least two siloxy units with a substituent capable of reacting via condensation. Suitable substitutes on the siloxy units of the organopolysiloxanes include silanol, alkoxy, acetoxy, oxime functional groups. In this embodiment, the silicone composition will further contain a catalyst known in the art for enhancing condensation cure of organopolysiloxanes such as a tin or titanium catalyst. In a further embodiment, the organopolysiloxane is a silanol endblocked polydimethylsiloxane having a kinematic viscosity that may range from 1 to 100,000 mm²/s (10⁻⁶ m²/s) at 25° C., or alternatively from 1 to 10,000 mm²/s (10⁻⁶ m²/s) at 25° C.

The silicone composition may contain organopolysiloxanes having at least one siloxy unit substituted with an organofunctional group. The organofunctional organopolysiloxanes useful in the present process are characterized by having at least one of the R groups in the formula RₙSiO_{(4-n)/2} be an organofunctional group. Representative non-limiting organofunctional groups include amino, amido, epoxy, mercapto, polyether (polyoxyalkylene) groups, and any mixture thereof. Further examples of organofunctional organopolysiloxanes include those having alkoxylated groups; hydroxyl groups such as the polyorganosiloxanes containing a hydroxyalkyl function, as described in EP1081272, U.S. Pat. No. 6,171,515 and U.S. Pat. No. 6,136,215; Bis-Hydroxy/Methoxy Amodimethicone; amino-acid functional siloxanes obtained by reacting an amino acid derivative selected from the group of an N-acyl amino acid and an N-aroyl amino acid with an amino functional siloxane, further described in WO2007/141565; quaternary ammonium functional silicones, described in U.S. Pat. No. 6,482,969 and U.S. Pat. No. 6,607,717, such as Silicone Quaternium-16 (CTFA designation); hydrocarbyl functional organopolysiloxanes comprising a siloxy unit of the formula R⁵R′ᵢSiO_{(3-i)/2} wherein R′ is any monovalent hydrocarbon group, but typically is an alkyl, cycloalkyl, alkenyl, alkaryl, aralkyl, or aryl group containing 1-20 carbon atoms, R⁵ is a hydrocarbyl group having the formula —R⁶OCH₂CH₂OH, wherein R⁶ is a divalent hydrocarbon group containing 2 to 6 carbon atoms and i has a value of from zero to 2, such as described in U.S. Pat. No. 2,823,218, U.S. Pat. No. 5,486,566, U.S. Pat. No. 6,060,044 and US20020524 (CTFA Bis-Hydroxyethoxypropyl Dimethicone); siloxane-based polyamide such as described in U.S. Pat. No. 6,051,216; silicone polyether-amide block copolymers such as described in US2008/0045687.

The organofunctional group may be present on any siloxy unit having an R substituent, that is, they may be present on any (R₃SiO_{1/2}), (R₂SiO), or (RSiO_{3/2}) unit.

The organofunctional group may be an amino-functional group. Amino-functional groups may be designated in the formulas herein as R^{N} and is illustrated by groups having the formula:

—R⁸NHR⁹, —R⁸NR⁹₂, or —R⁸NHR⁸NHR⁹, wherein

each R⁸ is independently a divalent hydrocarbon group having at least 2 carbon atoms, and
R⁹ is hydrogen or an alkyl group. Each R⁸ is typically an alkylene group having from 2 to 20 carbon atoms. Some examples of suitable amino-functional hydrocarbon groups are;
—CH₂CH₂NH₂, —CH₂CH₂CH₂NH₂, —CH₂CHCH₃NH, —CH₂CH₂CH₂CH₂NH₂, —CH₂CH₂CH₂CH₂CH₂NH₂, —CH₂CH₂CH₂CH₂CH₂CH₂NH₂, —CH₂CH₂NHCH₃, —CH₂CH₂CH₂NHCH₃, —CH₂(CH₃)CHCH₂NHCH₃, —CH₂CH₂CH₂CH₂NHCH₃, —CH₂CH₂NHCH₂CH₂NH₂, —CH₂CH₂CH₂NHCH₂CH₂NH₂, —CH₂CH₂CH₂NHCH₂CH₂CH₂NH₂, —CH₂CH₂CH₂CH₂NHCH₂CH₂CH₂CH₂NH₂, —CH₂CH₂NHCH₂CH₂NHCH₃, —CH₂CH₂CH₂NHCH₂CH₂CH₂NHCH₃, —CH₂CH₂CH₂CH₂NHCH₂CH₂CH₂CH₂NHCH₃, and —CH₂CH₂NHCH₂CH₂NHCH₂CH₂CH₂CH₃.

Examples of silicone resins include trimethylsilylsilicate (MQ resin), silsesquioxane resins (T resin), MQ-T resins, silsesquioxane resin waxes.

A trimethylsilylsilicate (MQ resin) may comprise ≧80 mole % of siloxy units selected from (R¹⁰₃SiO_{1/2})ₐ and (SiO_{4/2})_{d} units, where R¹⁰ is an alkyl group having from 1 to 8 carbon atoms, an aryl group, a carbinol group, or an amino group, with the proviso that ≧95 mole % of the R¹⁰ groups are alkyl groups, a and d>0, and the ratio of a/d=0.5 to 1.5.

MQ resins may contain D and T units, providing that ≧80 mole %, alternatively ≧90 mole % of the total siloxane units are M and Q units. The MQ resins may also contain hydroxy groups. Typically, the MQ resins have a total weight % hydroxy content of 2 to 10 weight %, alternatively 2 to 5 weight %. The MQ resins can also be further “capped” wherein residual hydroxy groups are reacted further with M groups.

A silsesquioxane resins (T resin) may comprise ≧30 mole % of R¹⁰SiO_{3/2} units, where R¹⁰ is as defined above. When ≧40 mole % of the R¹⁰ groups are propyl, the T resin may be named a propyl silsesquioxane resin.

T resins may contain M, D, and Q units, providing that ≧30 mole %, alternatively ≧80 mole %, alternatively ≧90 mole % of the total siloxane units are T units. The T resins may also contain hydroxy and/or alkoxy groups. Typically, the T resins have a total weight % hydroxy content of 2 to 10 weight % and a total weight % alkoxy content ≦20 weight %; alternatively 6 to 8 weight % hydroxy content and ≦10 weight % alkoxy content.

MQ and T organopolysiloxane resins may be used alone or combined together.

A MQ-T resin may have the formula (R¹¹₃SiO_{1/2})ₐ (R¹²₂SiO_{2/2})_{b} (R¹³SiO_{3/2})_{c} (SiO_{4/2})_{d} with R¹¹, R¹² and R¹³ independently represent an alkyl group containing from 1 to 8 carbon atoms, an aryl group, a carbinol group or an amino group, where 0.05≦a≦0.5; 0≦b≦0.3; c>0; 0.05≦d≦0.6, and a+b+c+d=1, with the proviso that ≧40 mole % of the R¹³ groups in the siloxane resin are propyl. Representatives of such MQ-T resins are taught in WO2005/075542.

A silsesquioxane resin wax may comprise at least 40 mole % of siloxy units having the formula (R¹⁰₂R¹⁴SiO_{1/2})ₓ(R¹⁵SiO_{3/2})_{y}, where x and y have a value of 0.05 to 0.95, R¹⁰ is as described above, R¹⁴ is a monovalent hydrocarbon having 9-40 carbon atoms, and R¹⁵ is a monovalent hydrocarbon group having 1 to 8 carbon atoms or an aryl group. R¹⁴ and the ratio of y/x are selected such that the silsesquioxane resin wax has a melting point of ≧30° C. Representatives of such silsesquioxane resin waxes are taught in U.S. Pat. No. 7,482,419.

Examples of silicone waxes include C30-45 alkyl methicone and C30-45 olefin (MP>60° C.), Bis-PEG-18 methyl ethyl dimethyl silane, stearyl dimethicone.

Silicone elastomers are a type of tri-dimensional crosslinked silicone polymers. Examples of silicone elastomers include those obtained from the crosslinking hydrosilylation reaction of an organohydrogenpolysiloxane with another polysiloxane containing an unsaturated hydrocarbon substituent, such as a vinyl functional polysiloxane, or by crosslinking an organohydrogenpolysiloxane with a hydrocarbon diene or with a terminally unsaturated polyoxyalkylene. Representative examples of such silicone elastomers are taught in U.S. Pat. No. 5,880,210 and U.S. Pat. No. 5,760,116. In some instances, organofunctional groups have been grafted onto the silicone organic elastomer backbone, such as alkyls, polyether, amines. Representative examples of such organofunctional silicone elastomers are taught in U.S. Pat. No. 5,811,487, U.S. Pat. No. 5,880,210, U.S. Pat. No. 6,200,581, U.S. Pat. No. 5,236,986, U.S. Pat. No. 6,331,604, U.S. Pat. No. 6,262,170, U.S. Pat. No. 6,531,540, and U.S. Pat. No. 6,365,670, WO2004/104013 and WO2004/103326.

Examples of saccharide-siloxane polymer include the reaction product of a functionalized organosiloxane polymer and at least one hydroxy-functional saccharide component comprising 5 to 12 carbon atoms, in such a way that the organosiloxane component is covalently linked via a linking group to the saccharide component. Saccharide-siloxane polymers may be linear or branched. Further examples of saccharide-siloxane polymers are taught in US20080199417, US20100105582, WO2012027073, WO2012027143.

Examples of vinyl polymer grafted with a carbosiloxane dendrimers include the reaction product of a vinyl polymer with at least one carbosiloxane dendrimer-based unit. The term “carbosiloxane dendrimer structure” designates a structure with branched groups of high molecular masses with high regularity in the radial direction starting from the simple backbone. Such carbosiloxane dendrimer structures are described in the form of a highly branched siloxane-silalkylene copolymer in the laid-open Japanese patent application Kokai 9-171 154. Other vinyl polymers grafted with a carbosiloxane dendrimer are taught in EP0963751.

The first dispersed phase may be a silicone intended to care for the fabric substrate or fibre, or a silicone intended to control foam in a laundry process.

The silicone, such as a foam control silicone, may be combined with a filler, such as silica.

### The Second Dispersed Phase of Bi-Modal Emulsion (E)

The bi-modal water continuous emulsions have a second dispersed phase containing a silicone that is provided from a water continuous silicone emulsion containing at least one surfactant (designated herein as component (B)). The water continuous silicone emulsion (B) containing at least one surfactant may be a single water continuous silicone emulsion, or a combination of water continuous silicone emulsions.

The water continuous silicone emulsion(s) (B) useful in the present bi-modal emulsions contains at least one surfactant. The surfactant may vary, but typically is chosen from those surfactants that enhance the formation of water continuous emulsions.

The surfactant may be an anionic surfactant, cationic surfactant, nonionic surfactant, amphoteric surfactant, or a mixture of any of these surfactants.

The silicone in the water continuous silicone emulsion containing at least one surfactant (B) may be any of those silicones listed above as hydrophobic oil (A), and mixtures thereof.

Examples of anionic surfactants include alkali metal, amine, or ammonium salts of higher fatty acids, alkylaryl sulphonates such as sodium dodecyl benzene sulfonate, long chain fatty alcohol sulfates, olefin sulfates and olefin sulfonates, sulfated monoglycerides, sulfated esters, sulfonated ethoxylated alcohols, sulfosuccinates, alkane sulfonates, phosphate esters, alkyl isethionates, alkyl taurates, alkyl sarcosinates, and mixtures thereof.

Examples of cationic surfactants include alkylamine salts, quaternary ammonium salts, sulphonium salts, and phosphonium salts. Examples of suitable nonionic surfactants include condensates of ethylene oxide with long chain fatty alcohols or fatty acids such as a C₁₂₋₁₆ alcohol, condensates of ethylene oxide with an amine or an amide, condensation products of ethylene and propylene oxide, esters of glycerol, sucrose, sorbitol, fatty acid alkylol amides, sucrose esters, fluoro-surfactants, fatty amine oxides, and mixtures thereof.

Examples of amphoteric surfactants include imidazoline compounds, alkylaminoacid salts, betaines, and mixtures thereof.

Examples of nonionic surfactants include polyoxyethylene fatty alcohols such as polyoxyethylene (23) lauryl ether, polyoxyethylene (4) lauryl ether; ethoxylated alcohols such as ethoxylated trimethylnonanol, C₁₂-C₁₄ secondary alcohol ethoxylates, ethoxylated, C10-Guerbet alcohol, ethoxylated, iso-C13 alcohol; poly(oxyethylene)-poly(oxypropylene)-poly(oxyethylene) tri-block copolymer (also referred to as poloxamers); tetrafunctional poly(oxyethylene)-poly(oxypropylene) block copolymer derived from the sequential addition of propylene oxide and ethylene oxide to ethylene diamine (also referred to as poloxamines), silicone polyethers, and mixtures thereof.

When mixtures containing nonionic surfactants are used, one nonionic surfactant may have a low Hydrophile-Lipophile Balance (HLB) and the other nonionic surfactant may have a high HLB, such that the two nonionic surfactants have a combined HLB of 11-15, alternatively a combined HLB of 12.5-14.5.

The water continuous silicone emulsion (B) may be selected from those considered in the art to be a “macro” or “micro” emulsion. In other words, the average particle size of the water continuous emulsion may vary from 0.001 to 1000 μm, alternatively from 0.01 to 20 μm, or alternatively from 0.02 to 10 μm.

The water continuous silicone emulsion (B) may be a microemulsion having an average particle size of less than 100 nm.

The water continuous silicone emulsion (B) may be considered an “emulsion polymer”, in other words, an emulsion formed by emulsion polymerization techniques. Examples of suitable silicone emulsions produced by emulsion polymerization techniques are taught in U.S. Pat. No. 2,891,920, U.S. Pat. No. 3,294,725, U.S. Pat. No. 5,661,215, U.S. Pat. No. 5,817,714, and U.S. Pat. No. 6,316,541.

The water continuous silicone emulsion (B) may be a mechanical emulsion. As used herein, mechanical emulsions refer to those emulsion in the art produced by using mechanical energy (such as from high shearing forces). Examples of silicone emulsions produced by mechanical techniques are taught in U.S. Pat. No. 6,395,790.

The water continuous silicone emulsion may be prepared using suspension polymerization techniques. Examples of silicone emulsions produced by suspension polymerization techniques are taught in U.S. Pat. No. 4,618,645, U.S. Pat. No. 6,248,855, and U.S. Pat. No. 6,395,790.

The present bi-modal water continuous emulsion (E) may be prepared by a process comprising:
I) forming a mixture comprising;
   A) 100 parts by weight of a hydrophobic oil,
   B) 1 to 1000 part by weight of a water continuous silicone emulsion having at least one surfactant,
II) admixing additional quantities of the water continuous emulsion and/or water to the mixture from step I) to form a bi-modal emulsion.

Component (A) in step I) of the above process may be any hydrophobic oil as described above as component (A) in the first dispersed phase.

Component (B) in step I) of the above process may be any water continuous silicone emulsion as described above as component (B) in the second dispersed phase.

Mixing in step I) can be accomplished by any method known in the art to effect mixing of high viscosity materials. The mixing may occur either as a batch, semi-continuous, or continuous process. Mixing may occur, for example using, batch mixing equipments with medium/low shear include change-can mixers, double-planetary mixers, conical-screw mixers, ribbon blenders, double-arm or sigma-blade mixers; batch equipments with high-shear and high-speed dispersers include those made by Charles Ross & Sons (NY), Hockmeyer Equipment Corp. (NJ); batch equipments with high shear actions include Banbury-type (CW Brabender Instruments Inc., NJ) and Henschel type (Henschel mixers America, TX). Illustrative examples of continuous mixers/compounders include extruders single-screw, twin-screw, and multi-screw extruders, co-rotating extruders, such as those manufactured by Krupp Werner & Pfleiderer Corp (Ramsey, N.J.), and Leistritz (NJ); twin-screw counter-rotating extruders, two-stage extruders, twin-rotor continuous mixers, dynamic or static mixers or combinations of these equipments.

The temperature and pressure at which the mixing of step I) occurs is not critical, but generally is conducted at ambient temperature and pressures. Typically, the temperature of the mixture will increase during the mixing process due to the mechanical energy associated when shearing such high viscosity materials.

Typically 1 to 1000 parts by weight of the water continuous emulsion are mixed for every 100 parts by weight of component (A) in the step I) mixture, alternatively from 5 to 500 parts per 100 parts by weight of component (A) in the step I) mixture, or alternatively from 5 to 100 parts per 100 parts by weight of component (A) the step I) mixture.

Step I) may involve forming a mixture consisting essentially of; 100 parts by weight of a hydrophobic oil (A), 1 to 1000 parts by weight of a water continuous emulsion (B) having at least one surfactant. In this embodiment, the mixture formed in step I) is “essentially free” from any other surfactant compounds or components other than components (A) and (B). As used herein, “essentially free” means no other surfactant compounds are added to the mixture formed in step I), other than the surfactant(s) present in (B) the water continuous emulsion.

Step II) of the process involves admixing additional quantities of the water continuous emulsion and/or water to the mixture from step I) to form a bi-modal emulsion.

The amount of the additional quantities of the water continuous emulsion and/or water used in step II) may vary depending on the selection of components (A) and (B). Typically the amount of additional water continuous emulsion and/or water admixed in step II) of the present process may vary from 1 to 1000 parts by weight of the step I) mixture, alternatively from 5 to 500 parts per 100 parts by weight, or alternatively from 5 to 100 parts per 100 parts by weight.

In step II) of the present process, additional quantities of the water continuous emulsion may be used alone, or alternatively be combined with varying quantities of water. Alternatively, additional quantities of water may be added alone without any additional quantities of the water continuous emulsion. The selection of using additional quantities of the water continuous emulsion alone, in combination with varying amounts of water, or water alone will depend on the initial selection of the water continuous emulsion and the desired physical properties of the resulting bi-modal emulsion. For example, high solids bi-modal emulsions may be prepared with only the addition of the water continuous emulsion. Conversely, low solids bi-modal emulsions may require the addition of water.

The water continuous emulsion and/or water is added to the mixture from step I) at such a rate, with additional mixing, so as to form an emulsion of the mixture of step I). The water continuous emulsion added to the mixture from step I) may be done in incremental portions, whereby each incremental portion comprises less than 50 weight % of the mixture from step I), alternatively 25 weight % of the mixture from step I), and each incremental portion of water continuous emulsion is added successively to the previous after the dispersion of the previous incremental portion of water continuous emulsion, wherein sufficient incremental portions of water continuous emulsion are added to form the bi-modal emulsion.

The number of incremental portions of the water continuous emulsion and/or water added to the mixture from step I) may vary, but typically at least 2, alternatively, at least 3 incremental portions are added.

Mixing in step II) can be accomplished by any method known in the art to effect mixing of high viscosity materials and/or effect the formation of an emulsion. The mixing may occur either as a batch, semi-continuous, or continuous process. Any of the mixing methods as described for step I), may be used to effect mixing in step II). Alternatively, mixing in step II) may also occur via those techniques known in the art to provide high shear mixing to effect formation of emulsions. Representative of such high shear mixing techniques include high speed stirrers, homogenizers, Sonolators®, Microfluidizers®, Ross mixers, Eppenbach colloid mills, Flacktek Speedmixers®, and other similar shear devices.

Optionally, the emulsion formed in step II) may be further sheared according to an optional step III) to reduce particle size and/or improve long term storage stability. The shearing may occur by any of the mixing techniques discussed above.

The bi-modal water continuous emulsions prepared by the present process may be characterized by their bi-modal particle size distribution. The particle size may be determined by laser diffraction of the emulsion. Suitable laser diffraction techniques are well known in the art. The particle size is obtained from a particle size distribution (PSD). The PSD can be determined on a volume, surface, length basis. The volume particle size is equal to the diameter of the sphere that has the same volume as a given particle. The term Dv, as used herein, represents the average volume particle size of the dispersed particles. Dv 50 is the particle size measured in volume corresponding to 50% of the cumulative particle population. In other words if Dv 50=10 μm, 50% of the particle have an average volume particle size below 10 μm and 50% of the particle have a volume average particle size above 10 μm. Dv 90 is the particle size measured in volume corresponding to 90% of the cumulative particle population. Mode 1 is the median of the distribution of one of the dispersed phase particle populations within a bimodal particle size distribution and Mode 2 is the median of the other.

In some instances, it may be necessary to conduct two separate evaluations of particle size, especially when the particle sizes distributions of the resulting bi-modal emulsions exhibit a wide variation in size. In these instances a Malvern-Mastersizer® 2000 may be used to obtain particle size distributions in the range 0.5 to 1000 μm, while a Microtrac-Nanotrac® may be used to measure particle size distributions in the ranges less than 0.5 μm.

The average volume particle size of the dispersed particles in the oil/water emulsions ranges of from 0.001 μm to 1000 μm; or of from 0.01 μm to 20 μm; or of from 0.02 μm to 10 μm.

Alternatively, the average volume particle size of each of the unique dispersed phases (that is the first dispersed phase, and the second dispersed phase), may be reported. The average volume particle size of the first dispersed particles in the oil/water emulsions ranges of from 0.1 μm to 500 μm; or of from 0.1 μm to 100 μm; or of from 0.2 μm to 30 μm. The average volume particle size of the second dispersed particles in the oil/water emulsions ranges of from 0.1 μm to 500 μm; or of from 0.1 μm to 100 μm; or of from 0.2 μm to 30 μm.

While not wishing to be bound by any theory, it is believed particle size distribution of the first dispersed phase results from the emulsification of the hydrophobic oil, while particle size distribution of the second dispersed phase results from the particles originating from the water continuous emulsion used in the present process. However, there may be certain instances where the two overlap sufficiently that a bi-modal distribution is not observable using the particle size determination techniques described above.

The bimodal particle size distribution may also be observed using optical microscopy techniques.

In some instances, there may be 3 modes in the resulting emulsion, such as to compose a tri-modal emulsion.

In some instances, the bi-modal emulsions may be considered as a “high solids” emulsion, wherein the bi-modal emulsion contains at least 75% by weight of components (A) and (B), alternatively the bi-modal emulsion contains at least 80% by weight of components (A) and (B), alternatively the bi-modal emulsion contains at least 85% by weight of components (A) and (B), alternatively the bi-modal emulsion contains at least 90% by weight of components (A) and (B).

The “high solids” bi-modal emulsion may remain pourable. Thus, the bi-modal emulsions may have a viscosity less than 600,000 mPa/s (10⁻³ Pa·s), alternatively less than 200,000 mPa/s (10⁻³ Pa·s), or alternatively less than 100,000 mPa/s (10⁻³ Pa·s), as measured at 25° C.

The total surfactant concentration in the bi-modal emulsion is less than 4.0 weight %, alternatively less than 1.0 weight %, or alternatively less than 0.2 weight %.

The bi-modal silicone emulsions produced by the present process contains less than 1.0 weight % cyclosiloxanes, alternatively contains less than 0.5 weight % cyclosiloxanes, alternatively contains less than 0.1 weight % cyclosiloxanes.

The bi-modal emulsion (E) may be composed, as first dispersed phase, of a trimethylsilyl terminated siloxane of viscosity of from 100 to 500 000 mm²/s (10⁻⁶ m²/s), an amino functional siloxane, and as second dispersed phase, an emulsion of a trimethylsilyl terminated siloxane of viscosity of from 100 to 100 000 mm²/s (10⁻⁶ m²/s), alternatively an emulsion of a trimethylsilyl terminated siloxane of viscosity of from 100 to 1000 mm²/s (10⁻⁶ m²/s), an emulsion of an amino functional siloxane. Such emulsion as second dispersed phase may be cationic, non ionic or anionic, and may be a mechanical emulsion or result from an “emulsion polymerization”.

The bi-modal water continuous emulsion (E) is present in a fabric care composition in conjunction with a fabric care ingredient (F), optionally in an acceptable medium.

Fabric care compositions include liquid detergents, solid detergents, pre-wash treatments, fabric softeners, color care treatments and the like, used in the care of fabric and fibres, that is, any product adapted to be applied to a fibre, fabric or textile e.g. clothing, in order to improve the appearance or condition of the fabric or textile. Said fibres, or fabrics and textiles made thereof, may be of animal, vegetal or synthetic origin. Examples of animal fibres include silk and protein fibres, such as wool, angora, mohair, cashmere. Examples of vegetal fibres include cellulose or cotton fibres. Examples of synthetic fibres include polyester, nylon, spandex and rayon acetate.

Acceptable medium include water, solvents, diluents, or mixtures and emulsions thereof. Solvents include low molecular weight organic solvents that are highly soluble in water, e.g., C1-C4 monohydric alcohols, C2-05 polyhydric alcohols including alkylene glycols, polyalkylene glycols, alkylene carbonates, and mixtures thereof. Typical solvents include ethanol, propanol, isopropanol, n-butyl alcohol, t-butyl alcohol, ethylene glycol, diethylene glycol, propylene glycol, dipropylene glycol, glycerol, propylene carbonate, and mixtures thereof.

Fabric care ingredients include surface active materials such as surfactants or detergents or emulsifiers, thickeners, water phase stabilizing agents, pH controlling agents, preservatives and biocides, proteins or amino-acids and their derivatives, pigments, colorants, silicone conditioning agents, cationic conditioning agents, non ionic conditioning agents, hydrophobic conditioning agents, UV absorbers, sunscreen agents, dyes, fragrances or perfume, antioxidants, soil release agents, oxidizing agents, reducing agents, propellant gases, dispersibility aids, inorganic salts, antibacterial agents, antifungal agents, bleaching agents, sequestering agents, enzymes, diluents and mixtures thereof.

Additional ingredients that may be used in the fabric care compositions include antifoam compounds, builders, abrasives, fabric softeners, optical brighteners, soil-suspending agents, dispersants, dye transfer inhibitors, dye sequestrants, color fixatives, anti re-deposition agents, fatty alcohols, colour care additives, ironing agents, suspending agents and others.

Examples of surface active materials may be anionic, cationic or non ionic, and include organomodified silicones such as dimethicone copolyol; oxyethylenated and/or oxypropylenated ethers of glycerol; oxyethylenated and/or oxypropylenated ethers of fatty alcohols such as ceteareth-30, C12-15 pareth-7; fatty acid esters of polyethylene glycol such as PEG-50 stearate, PEG-40 monostearate; saccharide esters and ethers, such as sucrose stearate, sucrose cocoate and sorbitan stearate, and mixtures thereof; phosphoric esters and salts thereof, such as DEA oleth-10 phosphate; sulphosuccinates such as disodium PEG-5 citrate lauryl sulphosuccinate and disodium ricinoleamido MEA sulphosuccinate; alkyl ether sulphates, such as sodium lauryl ether sulphate; isethionates; betaine derivatives; and mixtures thereof.

Further examples of nonionic surfactants include polyoxyethylene alkyl ethers, polyoxyethylene alkylphenol ethers, polyoxyethylene lauryl ethers, straight-chain, primary alcohol alkoxylates, straight-chain secondary alcohol alkoxylates, alkyl phenol alkoxylates, olefinic alkoxylates, branched chain alkoxylates, polyoxyethylene sorbitan monoleates, polyoxyethylene alkyl esters, polyoxyethylene sorbitan alkyl esters, polyethylene glycol, polypropylene glycol, diethylene glycol, ethoxylated trimethylnonanols, polyoxyalkylene-substituted silicones (rake or ABn types), silicone alkanolamides, silicone esters, silicone glycosides, and mixtures thereof.

Nonionic surfactants include dimethicone copolyols, fatty acid esters of polyols, for instance sorbitol or glyceryl mono-, di-, tri- or sesquioleates or stearates, glyceryl or polyethylene glycol laurates; fatty acid esters of polyethylene glycol (polyethylene glycol monostearate or monolaurate); polyoxyethylenated fatty acid esters (stearate or oleate) of sorbitol; polyoxyethylenated alkyl (lauryl, cetyl, stearyl or octyl)ethers.

Anionic surfactants include carboxylates (sodium 2-(2-hydroxyalkyloxy)acetate)), amino acid derivatives (N-acylglutamates, N-acylgly-cinates or acylsarcosinates), alkyl sulfates, alkyl ether sulfates and oxyethylenated derivatives thereof, sulfonates, isethionates and N-acylisethionates, taurates and N-acyl N-methyltaurates, sulfosuccinates, alkylsulfoacetates, phosphates and alkyl phosphates, polypeptides, anionic derivatives of alkyl polyglycoside (acyl-D-galactoside uronate), and fatty acid soaps, and mixtures thereof.

Amphoteric and zwitterionic surfactants include betaines, N-alkylamidobetaines and derivatives thereof, proteins and derivatives thereof, glycine derivatives, sultaines, alkyl polyaminocarboxylates and alkylamphoacetates, and mixtures thereof.

Examples of thickeners include acrylamide polymers and copolymers, acrylate copolymers and salts thereof (such as sodium polyacrylate), xanthan gum and derivatives, cellulose gum and cellulose derivatives (such as methylcellulose, methylhydroxypropylcellulose, hydroxypropylcellulose, polypropylhydroxyethylcellulose), starch and starch derivatives (such as hydroxyethylamylose and starch amylase), polyoxyethylene, carbomer, hectorite and hectorite derivatives, sodium alginate, arabic gum, cassia gum, guar gum and guar gum derivatives, cocamide derivatives, alkyl alcohols, gelatin, PEG-derivatives, saccharides (such as fructose, glucose) and saccharides derivatives (such as PEG-120 methyl glucose diolate), and mixtures thereof.

Examples of water phase stabilizing agents include electrolytes (e.g. alkali metal salts and alkaline earth salts, especially the chloride, borate, citrate, and sulfate salts of sodium, potassium, calcium and magnesium, as well as aluminum chlorohydrate, and polyelectrolytes, especially hyaluronic acid and sodium hyaluronate), polyols (glycerine, propylene glycol, butylene glycol, and sorbitol), alcohols such as ethyl alcohol, and hydrocolloids, and mixtures thereof.

Examples of pH controlling agents include any water soluble acid such as a carboxylic acid or a mineral acid such as hydrochloric acid, sulphuric acid, and phosphoric acid, monocarboxylic acid such as acetic acid and lactic acid, and polycarboxylic acids such as succinic acid, adipic acid, citric acid, and mixtures thereof.

Example of preservatives and biocides include paraben derivatives, hydantoin derivatives, chlorhexidine and its derivatives, imidazolidinyl urea, phenoxyethanol, silver derivatives, salicylate derivatives, triclosan, ciclopirox olamine, hexamidine, oxyquinoline and its derivatives, PVP-iodine, zinc salts and derivatives such as zinc pyrithione, glutaraldehyde, formaldehyde, 2-bromo-2-nitropropane-1,3-diol, 5-chloro-2-methyl-4-isothiazoline-3-one, 2-methyl-4-isothiazoline-3-one, and mixtures thereof.

Examples of proteins or amino-acids and their derivatives include those extracted from wheat, soy, rice, corn, keratin, elastin or silk. Proteins may be in the hydrolyzed form and they may also be quatemized, such as hydrolyzed elastin, hydrolyzed wheat powder, hydrolyzed silk. Examples of protein include enzymes such as hydrolases, cutinases, oxidases, transferases, reductases, hemicellulases, esterases, isomerases, pectinases, lactases, peroxidases, laccases, catalases, and mixtures thereof. Examples of hydrolases include proteases (bacterial, fungal, acid, neutral or alkaline), amylases (alpha or beta), lipases, mannanases, cellulases, collagenases, lisozymes, superoxide dismutase, catalase, and mixtures thereof.

Examples of pigments and colorants include surface treated or untreated iron oxides, surface treated or untreated titanium dioxide, surface treated or untreated mica, silver oxide, silicates, chromium oxides, carotenoids, carbon black, ultramarines, chlorophyllin derivatives and yellow ocher. Examples of organic pigments include aromatic types including azo, indigoid, triphenylmethane, anthraquinone, and xanthine dyes which are designated as D&C and FD&C blues, browns, greens, oranges, reds, yellows, etc, and mixtures thereof. Surface treatments include those treatments based on lecithin, silicone, silanes, fluoro compounds.

Examples of silicone conditioning agents include silicone oils such as dimethicone; silicone gums such as dimethiconol; silicone resins such as trimethylsiloxy silicate, polypropyl silsesquioxane; silicone elastomers; alkylmethylsiloxanes; organomodified silicone oils, such as amodimethicone, aminopropyl phenyl trimethicone, phenyl trimethicone, trimethyl pentaphenyl trisiloxane, silicone quaternium-16/glycidoxy dimethicone crosspolymer, silicone quaternium-16; saccharide functional siloxanes; carbinol functional siloxanes; silicone polyethers; siloxane copolymers (divinyldimethicone/dimethicone copolymer); acrylate or acrylic functional siloxanes; and mixtures or emulsions thereof.

Examples of cationic conditioning agents include guar derivatives such as hydroxypropyltrimethylammonium derivative of guar gum; cationic cellulose derivatives, cationic starch derivatives; quaternary nitrogen derivatives of cellulose ethers; quaternized triethanolamine esters (esterquats); homopolymers of dimethyldiallyl ammonium chloride; copolymers of acrylamide and dimethyldiallyl ammonium chloride; homopolymers or copolymers derived from acrylic acid or methacrylic acid which contain cationic nitrogen functional groups attached to the polymer by ester or amide linkages; polymeric quaternary ammonium salts of hydroxyethyl cellulose reacted with a fatty alkyl dimethyl ammonium substituted epoxide; polycondensation products of N,N′-bis-(2,3-epoxypropyl)-piperazine or piperazine-bis-acrylamide and piperazine; and copolymers of vinylpyrrolidone and acrylic acid esters with quaternary nitrogen functionality. Specific materials include the various polyquats Polyquaternium-7, Polyquaternium-8, Polyquaternium-10, Polyquaternium-11, and Polyquaternium-23. Other categories of conditioners include cationic surfactants such as cetyl trimethylammonium chloride, cetyl trimethylammonium bromide, stearyltrimethylammonium chloride, and mixtures thereof. In some instances, the cationic conditioning agent is also hydrophobically modified, such as hydrophobically modified quaternized hydroxyethylcellulose polymers; cationic hydrophobically modified galactomannan ether; and mixtures thereof.

Examples of non ionic conditioning agents include fatty acid partial esters of polyhydric alcohols, or anhydrides thereof, where the polyhydric alcohol portion of the ester can be ethylene glycol, glycerol, poly (e.g., di-, tri-, tetra, penta-, and/or hexa-) glycerol, xylitol, sucrose, erythritol, pentaerythritol, sorbitol or sorbitan and where the fatty acid portion of the ester is derived from fatty acids having from about 12 to about 30 carbon atoms, such as lauric acid, myristic acid, palmitic acid, stearic acid and behenic acid.

Examples of hydrophobic conditioning agents include guar derivatives; galactomannan gum derivatives; cellulose derivatives; and mixtures thereof.

Examples of fabric softening compounds include cationic and non-ionic compounds. Further examples of fabric softening compounds include polyalkyl quaternary ammonium salts such as distearyldimethyl ammonium chloride, di(hardened tallow alkyl) dimethyl ammonium chloride, dipalmityl hydroxyethyl methylammonium chloride, stearyl benzyl dimethylammonium chloride, N,N-di(tallowyl-oxy-ethyl)-N-methyl, N-(2-hydroxyethyl)ammonium chloride; ester-linked quaternary ammonium materials having one or more fully saturated alkyl chains, and mixtures thereof.

UV absorbers and sunscreen agents include those which absorb ultraviolet light between about 290-320 nanometers (the UV-B region) and those which absorb ultraviolet light in the range of 320-400 nanometers (the UV-A region).

Some examples of sunscreen agents are aminobenzoic acid, cinoxate, diethanolamine methoxycinnamate, digalloyl trioleate, dioxybenzone, ethyl 4-[bis(Hydroxypropyl)] aminobenzoate, glyceryl aminobenzoate, homosalate, lawsone with dihydroxyacetone, menthyl anthranilate, octocrylene, ethyl hexyl methoxycinnamate, octyl salicylate, oxybenzone, padimate O, phenylbenzimidazole sulfonic acid, red petrolatum, sulisobenzone, titanium dioxide, trolamine salicylate, and mixtures thereof.

Some examples of UV absorbers are acetaminosalol, allatoin PABA, benzalphthalide, benzophenone, benzophenone 1-12, 3-benzylidene camphor, benzylidenecamphor hydrolyzed collagen sulfonamide, benzylidene camphor sulfonic Acid, benzyl salicylate, bornelone, bumetriozole, butyl Methoxydibenzoylmethane, butyl PABA, ceria/silica, ceria/silica talc, cinoxate, DEA-methoxycinnamate, dibenzoxazol naphthalene, di-t-butyl hydroxybenzylidene camphor, digalloyl trioleate, diisopropyl methyl cinnamate, dimethyl PABA ethyl cetearyldimonium tosylate, dioctyl butamido triazone, diphenyl carbomethoxy acetoxy naphthopyran, disodium bisethylphenyl tiamminotriazine stilbenedisulfonate, disodium distyrylbiphenyl triaminotriazine stilbenedisulfonate, disodium distyrylbiphenyl disulfonate, drometrizole, drometrizole trisiloxane, ethyl dihydroxypropyl PABA, ethyl diisopropylcinnamate, ethyl methoxycinnamate, ethyl PABA, ethyl urocanate, etrocrylene ferulic acid, glyceryl octanoate dimethoxycinnamate, glyceryl PABA, glycol salicylate, homosalate, isoamyl p-methoxycinnamate, isopropylbenzyl salicylate, isopropyl dibenzolylmethane, isopropyl methoxycinnamate, menthyl anthranilate, menthyl salicylate, 4-methylbenzylidene, camphor, octocrylene, octrizole, octyl dimethyl PABA, ethyl hexyl methoxycinnamate, octyl salicylate, octyl triazone, PABA, PEG-25 PABA, pentyl dimethyl PABA, phenylbenzimidazole sulfonic acid, polyacrylamidomethyl benzylidene camphor, potassium methoxycinnamate, potassium phenylbenzimidazole sulfonate, red petrolatum, sodium phenylbenzimidazole sulfonate, sodium urocanate, TEA-phenylbenzimidazole sulfonate, TEA-salicylate, terephthalylidene dicamphor sulfonic acid, titanium dioxide, triPABA panthenol, urocanic acid, VA/crotonates/methacryloxybenzophenone-1 copolymer, and mixtures thereof.

A dye may generally be described as a coloured substance that has an affinity to the substrate to which it is being applied. Examples of dyes include anionic dyes (for example a direct dye or an acid dye), reactive dyes, nonionic dyes (for example a disperse dye) or pigment dyes (for example a vat dye). Direct dyes are generally large, planar, aromatic systems generally used to dye cotton, for example direct red 80 or direct black 56. Reactive dyes are medium sized generally used for cotton and wool having fibre-reactive terminal group which forms a covalent bond with an atom of the fabric, for example remazol brilliant blue R and procion blue 3G. Disperse dyes are compact, aromatic molecules used for polyester, or dark shades on nylon and include disperse blue 11. Vat dyes are used for cotton, mainly prints and denims. The water-soluble reduced form is oxidised in situ to form the insoluble dye. Examples include vat blue 4. Further examples of dyes include indigo extract, Lawsonia inermis (Henna) extract, 1-acetoxy-2-methylnaphthalene; 5-amino-4-chloro-o-cresol; 5-amino-2,6-dimethoxy-3-hydroxypyridine; 3-amino-2,6-dimethylphenol; 2-amino-5-ethylphenol HCl; 5-amino-4-fluoro-2-methylphenol sulfate; 4-amino-2-nitrophenol; 4-amino-3-nitrophenol; 2-amino-4-nitrophenol sulfate; m-aminophenol HCl; p-aminophenol HCl; m-aminophenol; o-aminophenol; 4,6-bis(2-hydroxyethoxy)-m-phenylenediamine HCl; 2-chloro-5-nitro-N-hydroxyethyl p-phenylenediamine; 2-chloro-p-phenylenediamine; 3,4-diaminobenzoic acid; 4,5-diamino-1-((4-chlorophenyl)methyl)-1H-pyrazole-sulfate; 2,3-diaminodihydropyrazolo pyrazolone dimethosulfonate; 2,6-diaminopyridine; 2,6-diamino-3-((pyridin-3-yl)azo)pyridine; dihydroxyindole; dihydroxyindoline; N,N-dimethyl-p-phenylenediamine; 2,6-dimethyl-p-phenylenediamine; N,N-dimethyl-p-phenylenediamine sulfate; direct dyes; 4-ethoxy-m-phenylenediamine sulfate; 3-ethylamino-p-cresol sulfate; N-ethyl-3-nitro PABA; gluconamidopropyl aminopropyl dimethicone; Haematoxylon brasiletto wood extract; HC dyes; hydroxyethyl-3,4-methylenedioxyaniline HCl; hydroxyethyl-2-nitro-p-toluidine; hydroxyethyl-p-phenylenediamine sulfate; 2-hydroxyethyl picramic acid; hydroxypyridinone; hydroxysuccinimidyl C21-22 isoalkyl acidate; isatin; Isatis tinctoria leaf powder; 2-methoxymethyl-p-phenylenediamine sulfate; 2-methoxy-p-phenylenediamine sulfate; 6-methoxy-2,3-pyridinediamine HCl; 4-methylbenzyl 4,5-diamino pyrazole sulfate; 2,2′-methylenebis 4-aminophenol; 2,2′-methylenebis-4-aminophenol HCl; 3,4-methylenedioxyaniline; p-phenylenediamine sulfate; phenyl methyl pyrazolone; N-phenyl-p-phenylenediamine HCl; pigment blue 15:1; pigment violet 23; pigment yellow 13; pyrocatechol; pyrogallol; resorcinol; sodium picramate; sodium sulfanilate; solvent yellow 85; solvent yellow 172; tetraaminopyrimidine sulfate; tetrabromophenol blue; 2,5,6-triamino-4-pyrimidinol sulfate; 1,2,4-trihydroxybenzene; and mixtures thereof.

Examples of fragrances or perfume include hexyl cinnamic aldehyde; anisaldehyde; methyl-2-n-hexyl-3-oxo-cyclopentane carboxylate; dodecalactone gamma; methylphenylcarbinyl acetate; 4-acetyl-6-tert-butyl-1,1-dimethyl indane; patchouli; olibanum resinoid; labdanum; vetivert; copaiba balsam; fir balsam; 4-(4-hydroxy-4-methyl pentyl)-3-cyclohexene-1-carboxaldehyde; methyl anthranilate; geraniol; geranyl acetate; linalool; citronellol; terpinyl acetate; benzyl salicylate; 2-methyl-3-(p-isopropylphenyl)-propanal; phenoxyethyl isobutyrate; cedryl acetal; aubepine; musk fragrances; macrocyclic ketones; macrolactone musk fragrances; ethylene brassylate; and mixtures thereof. Further perfume ingredients are described in detail in standard textbook references such as Perfume and Flavour Chemicals, 1969, S. Arctander, Montclair, N.J.

Examples of antioxidants are acetyl cysteine, arbutin, ascorbic acid, ascorbic acid polypeptide, ascorbyl dipalmitate, ascorbyl methylsilanol pectinate, ascorbyl palmitate, ascorbyl stearate, BHA, p-hydroxyanisole, BHT, t-butyl hydroquinone, caffeic acid, Camellia sinensis Oil, chitosan ascorbate, chitosan glycolate, chitosan salicylate, chlorogenic acids, cysteine, cysteine HCl, citric acid, decyl mercaptomethylimidazole, erythorbic acid, diamylhydroquinone, di-t-butylhydroquinone, dicetyl thiodipropionate, dicyclopentadiene/t-butylcresol copolymer, digalloyl trioleate, dilauryl thiodipropionate, dimyristyl thiodipropionate, dioleyl tocopheryl methylsilanol, isoquercitrin, diosmine, disodium ascorbyl sulfate, disodium rutinyl disulfate, distearyl thiodipropionate, ditridecyl thiodipropionate, dodecyl gallate, ethyl ferulate, ferulic acid, hydroquinone, hydroxylamine HCl, hydroxylamine sulfate, isooctyl thioglycolate, isopropyl citrate, kojic acid, madecassicoside, magnesium ascorbate, magnesium ascorbyl phosphate, melatonin, methoxy-PEG-7 rutinyl succinate, methylene di-t-butylcresol, methylsilanol ascorbate, nordihydroguaiaretic acid, octyl gallate, phenylthioglycolic acid, phloroglucinol, potassium ascorbyl tocopheryl phosphate, thiodiglycolamide, potassium sulfite, propyl gallate, rosmarinic acid, rutin, sodium ascorbate, sodium ascorbyl/cholesteryl phosphate, sodium bisulfite, sodium erythorbate, sodium metabisulfide, sodium sulfite, sodium thioglycolate, sorbityl furfural, tea tree (Melaleuca aftemifolia) oil, diethylenetriaminepentaacetic acid, tocopheryl acetate, tetrahexyldecyl ascorbate, tetrahydrodiferuloylmethane, tocopheryl linoleate/oleate, thiodiglycol, tocopheryl succinate, thiodiglycolic acid, thioglycolic acid, thiolactic acid, thiosalicylic acid, thiotaurine, retinol, tocophereth-5, tocophereth-10, tocophereth-12, tocophereth-18, tocophereth-50, tocopherol, tocophersolan, tocopheryl linoleate, tocopheryl nicotinate, tocoquinone, o-tolyl biguanide, tris(nonylphenyl) phosphite, ubiquinone, zinc dibutyldithiocarbamate, and mixtures thereof.

Examples of soil release agents include copolymeric blocks of terephthalate and polyethylene oxide or polypropylene oxide, and the like.

Examples of oxidizing agents are ammonium persulfate, calcium peroxide, hydrogen peroxide, magnesium peroxide, melamine peroxide, potassium bromate, potassium caroate, potassium chlorate, potassium persulfate, sodium bromate, sodium carbonate peroxide, sodium chlorate, sodium iodate, sodium perborate, sodium persulfate, strontium dioxide, strontium peroxide, urea peroxide, zinc peroxide, and mixtures thereof.

Examples of reducing agents are ammonium bisufite, ammonium sulfite, ammonium thioglycolate, ammonium thiolactate, cystemaine HCl, cystein, cysteine HCl, ethanolamine thioglycolate, glutathione, glyceryl thioglycolate, glyceryl thioproprionate, hydroquinone, p-hydroxyanisole, isooctyl thioglycolate, magnesium thioglycolate, mercaptopropionic acid, potassium metabisulfite, potassium sulfite, potassium thioglycolate, sodium bisulfite, sodium hydrosulfite, sodium hydroxymethane sulfonate, sodium metabisulfite, sodium sulfite, sodium thioglycolate, strontium thioglycolate, superoxide dismutase, thioglycerin, thioglycolic acid, thiolactic acid, thiosalicylic acid, zinc formaldehyde sulfoxylate, and mixtures thereof.

Examples of propellant gases include carbon dioxide, nitrogen, nitrous oxide, volatile hydrocarbons such as butane, isobutane, or propane, and chlorinated or fluorinated hydrocarbons such as dichlorodifluoromethane and dichlorotetrafluoroethane or dimethylether; and mixtures thereof. Dispersibility aids may be used to facilitate dispersion of the compositions in the rinse water.

Examples of dispersibility aids include those selected from the group consisting of mono-alkyl cationic quaternary ammonium compounds, mono-alkyl amine oxides, and mixtures thereof.

Examples of inorganic salts include any inorganic salt known in the art for addition to fabric softener compositions. Non-limiting examples of suitable inorganic salts include: MgI2, MgBr2, MgCl2, Mg(N03)2, Mg3 (PO4)2, Mg2P207, MgS04, magnesium silicate, NaI, NaBr, NaCl, NaF, Na3(PO4), NaS03, Na2S04, Na2S03, NaN03, NaI03, Na3 (PO4), Na4P207, sodium silicate, sodium metasilicate, sodium tetrachloroaluminate, sodium tripolyphosphate (STPP), Na2Si307, sodium zirconate, CaF2, CaCl2, CaBr2, CaI2, CaS04, Ca(N03)2, Ca, KI, KBr, KCl, KF, KN03, KIO3, K2SO4, K2SO3, K3(P04), K4(P207), potassium pyrosulfate, potassium pyrosulfite, LiI, LiBr, LiCl, LiF, LiNO3, AlF3, AlCl3, AlBr3, Alls, A12(SO4)3, A1(PO4), A1(NO3)3, aluminum silicate; including hydrates of these salts and including combinations of these salts or salts with mixed cations e. g. potassium alum AlK(SO4) 2 and salts with mixed anions, e. g. potassium tetrachloroaluminate and sodium tetrafluoroaluminate. Salts incorporating cations from groups Ma, IVa, Va, VIa, VIIa, VIII, Ib, and IIb on the periodic chart with atomic numbers>13 are also useful in reducing dilution. Salts with cations from group Ia or IIa with atomic numbers>20 as well as salts with cations from the lactinide or actinide series are useful in reducing dilution viscosity, and mixtures thereof.

Examples of antibacterial agents include chlorohexadiene gluconate, alcohol, benzalkonium chloride, benzethonium chloride, hydrogen peroxide, methylbenzethonium chloride, phenol, poloxamer 188, povidone-iodine, and mixtures thereof.

Examples of antifungal agents include miconazole nitrate, calcium undecylenate, undecylenic acid, zinc undecylenate, and mixtures thereof.

Examples of bleaching agents include chlorine bleaches such as chlorine, chlorine dioxide, sodium hypochlorite, calcium hypochlorite, sodium chlorate; peroxide bleaches such as hydrogen peroxide, sodium percarbonate, sodium perborate; reducing bleaches such as sodium dithionite, sodium borohydride; ozone; and mixtures thereof.

Examples of sequestering agents (also chealting agents) include phosphonates; amino carboxylic acid compounds (such as ethylenediamine tetraacetic acid (EDTA); N-hydroxyethylenediamine triacetic acid; nitrilotriacetic acid (NTA); and diethylenetriamine pentaacetic acid (DEPTA)); organo aminophosphonic acid compounds (such as ethylenediamine tetrakis (methylenephosphonic acid); 1-hydroxyethane 1,1-diphosphonic acid (HEDP); and aminotri (methylenephosphonic acid)); and mixtures thereof.

Examples of enzymes include lipases, cellulases, proteases, amylases, mannanases, pectate lyases, and mixtures thereof.

The formulations of the present invention also include diluents. Such diluents are often necessary to decrease the viscosity of the formulation sufficiently for application.

Examples of diluents include silicon containing diluents such as hexamethyldisiloxane, octamethyltrisiloxane, and other short chain linear siloxanes such as octamethyltrisiloxane, decamethyltetrasiloxane, dodecamethylpentasiloxane, tetradecamethylhexasiloxane, hexadeamethylheptasiloxane, heptamethyl-3-{(trimethylsilyl)oxy)}trisiloxane, cyclic siloxanes such as hexamethylcyclotrisiloxane, octamethylcyclotetrasiloxane, decamethylcyclopentasiloxane, dodecamethylcyclohexasiloxane; organic diluents such as butyl acetate, alkanes, alcohols, ketones, esters, ethers, glycols, glycol ethers, hydrofluorocarbons or any other material which can dilute the formulation without adversely affecting any of the component materials of the cosmetic composition. Hydrocarbons include isododecane, isohexadecane, Isopar L (C11-C13), Isopar H (C11-C12), hydrogenated polydecene. Ethers and esters include isodecyl neopentanoate, neopentylglycol heptanoate, glycol distearate, dicaprylyl carbonate, diethylhexyl carbonate, propylene glycol n butyl ether, ethyl-3 ethoxypropionate, propylene glycol methyl ether acetate, tridecyl neopentanoate, propylene glycol methylether acetate (PGMEA), propylene glycol methylether (PGME), octyldodecyl neopentanoate, diisobutyl adipate, diisopropyl adipate, propylene glycol dicaprylate/dicaprate, and octyl palmitate. Additional organic diluents include fats, oils, fatty acids, and fatty alcohols.

The general level of bi-modal water continuous emulsion (E) in the fabric care compositions may vary from 0.1% to 80% by weight, alternatively from 0.2% to 10%, alternatively from 0.5% to 5%, relative to the total weight of the fabric care composition. The fabric care ingredient (F) is present at a level of from 0.01% to 99.99% by weight, relative to the total weight of the cosmetic composition. The fabric care ingredient (F) may be a mixture of fabric care ingredients (F) as listed above.

In some instances, the bi-modal water continuous emulsion (E) is used in conjunction with a fabric care ingredient (F) selected from a cationic conditioning agent, a hydrophobic conditioning agent, or mixtures thereof, in an acceptable medium.

The fabric care composition may be prepared by a process comprising the steps of
i. Mixing a bi-modal water continuous emulsion (E) comprising at least 70 weight percent of: a first dispersed phase containing a hydrophobic oil, wherein the hydrophobic oil is provided as a non-emulsified hydrophobic oil, a second dispersed phase containing a silicone, wherein the silicone is provided from a water continuous silicone emulsion containing at least one surfactant; in an aqueous phase
ii. and at least one fabric care ingredient (F),
iii. optionally in the presence of an acceptable medium.

The cosmetic compositions may be prepared by mixing the bi-modal water continuous emulsion (E) in the aqueous phase with the appropriate aqueous phase ingredients, and optionally provide for a non aqueous phase, and mix the aqueous and non aqueous phases together, optionally under heating.

The process may be conducted at temperatures ranging of from 15 to 90° C., alternatively of from 20 to 60° C., alternatively at room temperature (25° C.), using simple propeller mixers, counter-rotating mixers, or homogenizing mixers. No special equipment or processing conditions are typically required. Depending on the type of composition prepared, the method of preparation will be different, but such methods are well known in the art.

The fabric care compositions comprising the bi-modal water continuous emulsion (E) may be adapted for use in a washing machine or for use when hand washing. The fabric care compositions according to the present invention may be in liquid, paste, laundry bar, or granular form. Other forms of the fabric care compositions include creams, gels, foams, sprays or aerosols. The fabric care compositions may be in the form of monophasic systems, biphasic or alternate multi phasic systems; emulsions, e.g. oil-in-water, water-in-oil, silicone-in-water, water-in-silicone; multiple emulsions, e.g. oil-in-water-in-oil, polyol-in-silicone-in-water, oil-in-water-in-silicone.

A laundry process is necessary in order to remove dirt, stains and malodours from fabrics or textiles, in particular clothes and household fabrics. However, the laundry process involves harsh conditions which often result in damage to the fabric such as fabric pilling, shrinkage and loss of color intensity and/or loss of color definition.

A fabric-softening composition may be used in the laundry process to prevent static cling in a laundered fabric and thereby make the fabric softer. Color-care additive are meant to retain the integrity of its color, for example the intensity and shade of color of the fabric.

The bi-modal water continuous emulsions (E) may be used in its liquid, pourable form, or may be granulated/agglomerated to be combined in the fabric care compositions. When provided in a granular form, the granular compositions may be made by combining base granule ingredients, e. g., surfactants, builders, water, etc., as a slurry, and spray drying the resulting slurry to a low level of residual moisture (5-12%). In some instances, additional ingredients may be added during the granulation process such as color-care additive, fragrances.

The fabric care compositions may be prepared by admixing the liquid, pourable bi-modal water continuous emulsion (E) with other liquid ingredients of the fabric care compositions. When solid, the fabric care compositions may be prepared by admixing the granulated form of the bi-modal water continuous emulsions (E) with the further ingredients, or by spray drying/agglomerating liquid fabric care compositions comprising the bi-modal water continuous emulsion (E).

Benefits obtained from using a fabric care composition comprising the bi-modal water continuous emulsions (E) include one or more of the following benefits: fabric softening and/or feel enhancement, garment shape retention and/or recovery and/or elasticity, ease of ironing, color care, anti-abrasion, anti-pilling, silicone deposition, water absorbency, reduction and/or removal and/or prevention of wrinkles fabric enhancement (or conditioning), or any combination thereof. In a dyeing process, benefits include color fastness, color absorbency, color long lasting.

The invention also comprises a method of treating fabric substrates and fibres, by applying to it a fabric care composition according to the first aspect of the invention.

A process of washing fabric substrates and fibres comprises the steps of
i. Mixing a bi-modal water continuous emulsion (A) comprising at least 70 weight percent of: a first dispersed phase containing a hydrophobic oil, wherein the hydrophobic oil is provided as a non-emulsified hydrophobic oil, a second dispersed phase containing a silicone, wherein the silicone is provided from a water continuous silicone emulsion containing at least one surfactant;
   with at least one fabric care ingredient (F) optionally in the presence of an acceptable medium,
ii. Applying the mixture to the fabric substrates and fibres;
iii. Optionally let the mixture stand on the fabric substrates and fibres;
iv. Optionally rinsing the fabric substrates and fibres.

A process of conditioning fabric substrates and fibres comprises the steps of
i. Mixing a bi-modal water continuous emulsion (A) comprising at least 70 weight percent of: a first dispersed phase containing a hydrophobic oil, wherein the hydrophobic oil is provided as a non-emulsified hydrophobic oil, a second dispersed phase containing a silicone, wherein the silicone is provided from a water continuous silicone emulsion containing at least one surfactant;
   with at least one fabric care ingredient (F) selected from cationic conditioning agent, non ionic conditioning agent, hydrophobic conditioning agent, optionally in the presence of an acceptable medium,
ii. Applying the mixture to the fabric substrates and fibres;
iii. Optionally let the mixture stand on the fabric substrates and fibres;
iv. Optionally rinsing the fabric substrates and fibres.

The optional standing time of the process of caring or conditioning fabric substrates and fibres may range of from 10 seconds to 24 hours, alternatively of from 10 minutes to 12 hours, alternatively of from 10 minutes to 3 hours.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention. All percentages are in wt. %. All measurements were conducted at 23° C. unless indicated otherwise.

### Emulsion 1

Emulsification of dimethicone 100,000 mPa/s (A) with an emulsion of dimethiconol (and) TEA-dodecylbenzenesulfonate (B—60% silicone): 32.74 g of 100,000 mPa/s dimethicone, was weighed into a cup followed by 6.55 g of emulsion (B). The cup was closed and placed inside a DAC-150 SpeedMixer® and the cup was spun at maximum speed (3450 RPM) for 30 seconds. The cup was opened and the walls of the cup were scraped with a spatula and the cup was spun again at maximum speed for 30 seconds. 5 g of emulsion (B) was weighed into the cup and the cup was spun for 30 seconds at approximately 2500 RPM. 15.7 g of emulsion (B) was added and the cup was again spun for 30 seconds at approximately 2500 RPM. The resulting emulsion (E) consisted of an aqueous oil-in-water (o/w) emulsion of silicone polymer having a total silicone content of approximately 81.05 percent. On a dry basis, this emulsion (E) contained approximately 77 percent 100,000 mPa/s dimethicone as large particles and 23 percent dimethiconol as smaller particles. Particle size of the emulsion (E) was determined using a Malvern Mastersizer®. The particle size curve showed two distinct peaks, one centered at 6.5 μm and another that was centered at 35 μm. Particle size as calculated by the instrument was as follows: Dv50=8.68 μm, Dv90=19.82 μm, Mode 1=0.73 μm, Mode 2=11.81 μm.

### Emulsion 2

Emulsification of dimethicone 100,000 mPa/s (A) with an emulsion of dimethiconol (and) TEA-dodecylbenzenesulfonate (B—60% silicone) and with siloxylated polyether EO/PO co-polymer: this example is processed as Example 1, with the addition of 2.99 g. of siloxylated polyether EO/PO co-polymer. The particle size curve showed two distinct peaks, one centered at 6.5 μm and another that was centered at 35 μm. Particle size as calculated by the instrument was as follows: Dv50=9.3 μm, Dv90=21.16 μm, Mode 1=0.73 μm, Mode 2=12.38 μm.

### Emulsions 3 to 6

These were prepared in a similar manner as Emulsions 1 and 2 above, with contents as listed in Table 1.

TABLE 1

| | Emul- | Emul- | Emul- | Emul- |
|---|---|---|---|---|
| Material (%) | sion 3 | sion 4 | sion 5 | sion 6 |
| Dimethicone 600,000 | 83.00 | 92.00 | 80.00 | 90.00 |
| mPa/s | | | | |
| Divinyldimethicone/ | 15.00 | | | |
| Dimethicone Copolymer | | | | |
| and C12-13 Pareth-23 | | | | |
| and C12-13 Pareth-3 | | | | |
| (60% silicone emulsion) | | | | |
| (Comparative emulsion | | | | |
| 3) | | | | |
| Dimethiconol (and) | | 6.00 | | |
| TEADodecylbenzene- | | | | |
| sulfonate (and) | | | | |
| Laureth-23 (25% | | | | |
| silicone emulsion) | | | | |
| (Comparative emulsion | | | | |
| 4) | | | | |
| Dimethiconol (and) | | | 20.00 | |
| TEADodecylbenzene- | | | | |
| sulfonate (60% | | | | |
| silicone emulsion) | | | | |
| (Comparative emulsion | | | | |
| 1) | | | | |
| Dimethiconol (and) | | | | 9.00 |
| TEADodecylbenzene- | | | | |
| sulfonate (51% | | | | |
| silicone emulsion) | | | | |
| (Comparative emulsion | | | | |
| 5) | | | | |
| Water | 2.00 | 2.00 | 0.00 | 1.00 |
| Total silicone (%) | 92.00 | 93.50 | 92.00 | 94.59 |
| Particle sizes | | | | |
| Primary Particle Size | 8.47 | 20.57 | 31.34 | 36.49 |
| (microns) | | | | |
| Secondary Particle size | 0.953 | 0.697 | NM | NM |
| (microns) | | | | |
| D(50) Particle Size | 8.73 | 20.76 | 28.08 | 36.71 |
| (microns) | | | | |
| D(90) Particle Size | 17.89 | 44.92 | 67.25 | 89.86 |
| (microns) | | | | |

### Emulsion 7

Emulsification of (A) as a trimethylsiloxy terminated siloxane having a viscosity of 100,000 mm²/s, with a non ionic emulsion (B) of a trimethylsiloxy terminated siloxane having a viscosity of 350 mm²/s (B—60% wt silicone, 0.319 μm): 2.00 g of emulsion (B), 34.15 g of (A), 0.09 g Lutensol XP79 (non-ionic ethoxylate of alkyl polyethylene glycol ethers based on the C10-Guerbet alcohol) were weighed into a cup. 5.00 g of glass beads were added to provide additional shear. The cup was closed and placed inside a DAC-150 SpeedMixer® and the cup was spun at maximum speed (3450 RPM) for 30 seconds. An additional 2.02 g of emulsion (B) was added to the cup and the cup was spun for 30 seconds at 3450 RPM. An additional 4.00 g of emulsion (B) was added to the cup and the cup was spun for 30 seconds at 3450 RPM. An additional 8.00 g of emulsion (B) was added to the cup and the cup was spun for 30 seconds at 3450 RPM. An additional 5.07 g of emulsion (B) was added to the cup and the cup was spun for 30 seconds at 3450 RPM. An additional 4.01 g of emulsion (B) was added to the cup and the cup was spun for 30 seconds at 3450 RPM. An additional 10.00 g of emulsion (B) was added to the cup and the cup was spun for 30 seconds at 3450 RPM.

The resulting emulsion (E7) consisted of an aqueous oil-in-water (o/w) emulsion of silicone polymer having a total silicone content of 79.62 percent weight. Particle size of the emulsion (E7) was determined using a Malvern Mastersizer®. The particle size curve showed two distinct peaks, one centered at 0.849 μm and another that was centered at 4.252 μm.

### Emulsion 8

Emulsification of (A) as an amino functional siloxane having a viscosity of 5000 mm²/s (INCI Bis-Hydroxy/Methoxy Amodimethicone), with a non ionic emulsion (B) of a trimethylsiloxy terminated siloxane having a viscosity of 350 mm²/s (B—60% wt silicone, 0.319 μm): 7.01 g of emulsion (B), 29.61 g of amino functional siloxane, were weighed into a cup. The cup was closed and placed inside a DAC-150 SpeedMixer® and the cup was spun at maximum speed (3450 RPM) for 30 seconds. The sides of the cup were scraped and the mixture was spun at maximum speed (3450 RPM) for 30 seconds. An additional 6.99 g of emulsion (B) was added to the cup and the cup was spun for 30 seconds at 3450 RPM. An additional 3.98 g of emulsion (B) was added to the cup and the cup was spun for 30 seconds at 3450 RPM.

The resulting emulsion (E8) consisted of an aqueous oil-in-water (o/w) emulsion of silicone polymer having a total silicone content of 84.89 percent weight. Particle size of the emulsion (E8) was determined using a Malvern Mastersizer®. The particle size curve showed two distinct peaks, one centered at 0.894 μm and another that was centered at 8.737 μm.

### Emulsion 9

Emulsification of (A) as a trimethylsiloxy terminated siloxane having a viscosity of 350 mm²/s, with a cationic emulsion (B) of amino functional siloxane (B—35% silicone, cetrimonium chloride and trideceth-12, 0.178 μm): 8.02 g of emulsion (B), 42.88 g of (A), were weighed into a cup. The cup was closed and placed inside a DAC-150 SpeedMixer® and the cup was spun at maximum speed (3450 RPM) for 30 seconds. An additional 4.00 g of emulsion (B) was added and the mixture was spun for 30 seconds at 3450 RPM.

The resulting emulsion (E9) consisted of an aqueous oil-in-water (o/w) emulsion of silicone polymer having a total silicone content of 85.48 percent weight. Particle size of the emulsion (E9) was determined using a Malvern Mastersizer®, for only the larger particles with Mode 2=10.389 μm. The Dv50 of the initial emulsion (B), as measured by a Microtrac Nanotrac 150, is of 0.178 μm. These smaller particles cannot effectively be measured when the larger particles are present, because of the optical effect of the larger particles on the measurement apparatus. Nevertheless, evidence of the presence of such smaller particles is made by the flowable character of Emulsion 9 which would not be the case if only large particles were present at such high silicone content.

### Emulsion 10

Emulsification of (A) as an antifoam compound based on a mixture of trimethylsiloxy terminated siloxane having a viscosity of 500 mm²/s, dimethyl siloxane and silica; with a non ionic emulsion (B) of a trimethylsiloxy terminated siloxane having a viscosity of 350 mm²/s (B—60% wt silicone, 0.319 μm): 20.03 g of emulsion (B), 7.48 g of (A), were weighed into a glass jar, and placed in a Sonicator S-4000, set to amplitude 100, and mixed for 30 s. The emulsion was transferred to a Max 40 dental cup, and mixed on the DAC 150 Speedmixer at 3500 rpm for 30 s.

The resulting emulsion (E10) consisted of an aqueous oil-in-water (o/w) emulsion of silicone polymer having a total silicone content of 70.88 percent weight. Particle size of the emulsion (E10) was determined using a Malvern Mastersizer®. The particle size curve showed two distinct peaks, one centered at 0.661 μm and another that was centered at 2.178 μm.

### Emulsion 11

Emulsification of (A) as an antifoam compound based on a mixture of trimethylsiloxy terminated siloxane having a viscosity of 1000 mm²/s, dimethyl siloxane, MQ resin and silica; with a non ionic emulsion (B) of a trimethylsiloxy terminated siloxane having a viscosity of 350 mm²/s (B—60% wt silicone, 0.319 μm): 20.00 g of emulsion (B), 7.53 g of (A), were weighed into a glass jar, and placed in a Sonicator S-4000, set to amplitude 100, and mixed for 60 s, the mixing was repeated for 30 s. The emulsion was transferred to a Max 40 dental cup, and mixed on the DAC 150 Speedmixer at 3500 rpm for 30 s. The cup was then placed in the Sonicator S-4000, set to amplitude 100, and mixed for 10 s.

The resulting emulsion (E11) consisted of an aqueous oil-in-water (o/w) emulsion of silicone polymer having a total silicone content of 70.94 percent weight. Particle size of the emulsion (E10) was determined using a Malvern Mastersizer®. The particle size curve showed two distinct peaks, one centered at 1.385 μm and another that was centered at 14.447 μm.

### Comparative Emulsion 1

Non ionic emulsion (B) of a trimethylsiloxy terminated siloxane having a viscosity of 350 mm²/s, at 60% wt active.

### Comparative System 2

Addition of 0.0518 g of non ionic emulsion (B) of a trimethylsiloxy terminated siloxane having a viscosity of 350 mm²/s with trimethylsiloxy terminated siloxane having a viscosity of 100,000 mm²/s directly in 6.0275 g of the fabric softener (16% wt esterquat dispersion), followed by the addition of 0.0294 g of the trimethylsiloxy terminated siloxane (A) having a viscosity of 100,000 mm²/s, to reach an active level of silicone of 1% wt—this Comparative system 2 is not within the scope of the invention, as it is not a bimodal emulsion, but rather the dispersion of the individual components (A) and (B) as used in Emulsion 7 directly in the fabric softener system.

### Comparative System 3

1:1 mixture of non ionic emulsion (B) of a trimethylsiloxy terminated siloxane having a viscosity of 350 mm²/s (60% wt silicone) with a non ionic emulsion of trimethylsiloxy terminated siloxane having a viscosity of 100,000 mm²/s (67.5% wt silicone, Dv50=2.1 μm) resulting in an emulsion of 54% wt active silicone—this Comparative system 3 is not within the scope of the invention, as it is the result of a combination of 2 emulsions, and not the result of the addition of a hydrophobic oil (A) to an emulsion (B).

### Comparative Emulsion 4

Non ionic emulsion of a mixture of trimethylsiloxy terminated siloxane having a viscosity of 350 mm²/s with a trimethylsiloxy terminated siloxane having a viscosity of 100,000 mm²/s (74.2% wt silicone, Dv50=0.981 μm) resulting in a mono-modal emulsion: 5.09 g of a trimethylsiloxy terminated siloxane having a viscosity of 350 mm²/s were mixed with 5.22 g of trimethylsiloxy terminated siloxane having a viscosity of 100,000 mm²/s directly, and emulsified in a mixture of non ionic surfactants containing 0.76 g of tricosaethylene glycol ether and 0.86 g of Alkyl polyglycol ether, and 1.96 g of water, in a DAC-150 SpeedMixer®—this Comparative system 4 is not within the scope of the invention, as it is a mono-modal emulsion of a combination of hydrophobic oils, and not a bimodal emulsion resulting from the addition of a hydrophobic oil (A) to an emulsion (B).

### Softness Testing

The bi-modal emulsions were evaluated for their impact on softness of terry towels, prepared as per the below method:

A 1 kg fabric load composed of 4 little terry towels (further used for panel test)+5 pillow cases (as ballast-recycled) is washed and treated with a softening composition, and line dried overnight before being used for panel test.

Test conditions:
Washing Machine: Miele W377
Water Hardness: 0 dH
Water quantity: not fixed
Detergent powder: Dash powder (10 g)—Added in the drum of the washing machine
Fabric softener: lab made dispersion of esterquat at 16% in water, to which is added the amount of emulsion or comparative system at the level of active indicated in Table 2, under mixing using a magnetic stirrer during 5 min, 24 h before the test
6 g of prepared fabric softening composition are then placed in the softener compartment of the washing machine, which will dispense the composition automatically at the last rinse
Panel test: 16 assessors are asked to indicate which terry towel is the softest, when presented with 2 terry towels treated with different softening compositions

TABLE 2
Test comparison

| | | |
|---|---|---|
| Emulsion 7-1% | Comparative | Equivalent softness performance, |
| active silicone | emulsion 1-1% | with trend for softness |
| | active silicone | improvement for Emulsion 7 |
| Emulsion 7-0.75% | Comparative | Equivalent softness performance |
| active silicone | emulsion 1-1% | for Emulsion 7 at 0.75% active |
| | active silicone | level vs Comparative emulsion 1, |
| | | with trend for softness |
| | | improvement for Emulsion 7 |
| Emulsion 7-0.50% | Comparative | Equivalent softness for Emulsion |
| active silicone | emulsion 1-1% | 7 at 0.50% active level vs |
| | active silicone | Comparative emulsion 1 |
| Comparative | Comparative | Significant improvement of |
| emulsion 1-1% | system | softness benefit for Comparative |
| active silicone | 2-1% active | system 2 over Comparative |
| | silicone | emulsion 1, but it is instable |
| | | as shown by phase separation |
| | | of the fabric softener containing |
| | | Comparative system 2 while the |
| | | fabric softener containing |
| | | Comparative emulsion 1 remains |
| | | stable in time |
| Comparative | Comparative | Equivalent softness performance |
| emulsion 1-1% | system 3-1% | for both emulsions |
| active silicone | active silicone | |
| Comparative | Comparative | Equivalent softness performance, |
| emulsion 1-1% | emulsion 4-1% | with trend for softness |
| active silicone | active silicone | improvement for Comparative |
| | | emulsion 1 |
| Emulsion 7-1% | Comparative | Equivalent softness performance |
| active silicone | system 3-1% | |
| | active silicone | |
| Emulsion 7-1% | Comparative | Equivalent softness performance |
| active silicone | emulsion 4-1% | |
| | active silicone | |

### Detergent Composition

The bi-modal emulsions 10 and 11 were included in a detergent composition as per Table 3:

TABLE 3

| | Detergent | Detergent |
|---|---|---|
| | composition 1 | composition 2 |
| Ingredient | (% wt) | (% wt) |
| Water | 83.64 | 83.64 |
| Propylene glycol | 2.00 | 2.00 |
| Sodium xylene sulfonate | 0.82 | 0.82 |
| Linear potassium | 6.13 | 6.13 |
| alklylbenzene sulfonate | | |
| Alcohol ethoxylate | 3.02 | 3.02 |
| Sodium lauryl ether | 2.14 | 2.14 |
| sulfate | | |
| Sodium citrate | 2.00 | 2.00 |
| Emulsion 10 | 0.25 | — |
| Emulsion 11 | — | 0.25 |

1. A fabric care composition comprising:
a bi-modal water continuous emulsion (E) comprising at least 70 weight percent of: a first dispersed phase containing a hydrophobic oil, wherein the hydrophobic oil is provided as a non-emulsified hydrophobic oil, and a second dispersed phase containing a silicone, wherein the silicone is provided from a water continuous silicone emulsion containing at least one surfactant;
and at least one fabric care ingredient (F),
optionally in an acceptable medium.

2. The fabric care composition of claim 1, where the hydrophobic oil of the first dispersed phase is selected from an organic oil, a silicone, or mixtures thereof.

3. The fabric care composition of claim 1, where the dispersed phase containing a silicone is selected from a “macro” emulsion or a “micro” emulsion.

4. The fabric care composition of claim 1, where the fabric care ingredient (F) is selected from surface active materials, surfactants, detergents, emulsifiers, thickeners, water phase stabilizing agents, pH controlling agents, preservatives, biocides, proteins or amino-acids and their derivatives, pigments, colorants, silicone conditioning agents, cationic conditioning agents, nonionic conditioning agents, hydrophobic conditioning agents, UV absorbers, sunscreen agents, dyes, fragrances, perfume, antioxidants, soil release agents, oxidizing agents, reducing agents, propellant gases, dispersibility aids, inorganic salts, antibacterial agents, antifungal agents, bleaching agents, sequestering agents, enzymes, diluents, antifoam compounds, builders, abrasives, fabric softeners, optical brighteners, soil-suspending agents, dispersants, dye transfer inhibitors, dye sequestrants, color fixatives, anti-re-deposition agents, fatty alcohols, colour care additives, ironing agents, suspending agents, and mixtures thereof.

5. The fabric care composition of claim 1, where the fabric care ingredient (F) is selected from a cationic conditioning agent, a nonionic conditioning agent, a hydrophobic conditioning agent, and mixtures thereof.

6. The fabric care composition of claim 1, which is in the form of a liquid, paste, laundry bar, granular form, cream, gel, foam, spray or aerosol.

7. A process for preparing the fabric care composition of claim 1, the process comprising the step of:
mixing the bi-modal water continuous emulsion (E)
and the fabric care ingredient (F),
optionally in the presence of an acceptable medium.

8. The process according to claim 7, where the fabric care composition is prepared by mixing the bi-modal water continuous emulsion (E) in the aqueous phase with aqueous phase ingredients, and optionally provide for a non aqueous phase, and mix the aqueous and non aqueous phases together, optionally under heating.

9. A process of washing fabric substrates and fibres, the process comprising the steps of:
mixing a bi-modal water continuous emulsion (E) comprising at least 70 weight percent of: a first dispersed phase containing a hydrophobic oil, wherein the hydrophobic oil is provided as a non-emulsified hydrophobic oil, and a second dispersed phase containing a silicone, wherein the silicone is provided from a water continuous silicone emulsion containing at least one surfactant; with at least one fabric care ingredient (F), optionally in the presence of an acceptable medium, to form a mixture; and
applying the mixture to the fabric substrates and fibres; and
optionally letting the mixture stand on the fabric substrates and fibres; and/or
optionally rinsing the fabric substrates and fibres.

10. A process of conditioning fabric substrates and fibres, the process comprising the steps of:
mixing a bi-modal water continuous emulsion (E) comprising at least 70 weight percent of: a first dispersed phase containing a hydrophobic oil, wherein the hydrophobic oil is provided as a non-emulsified hydrophobic oil, and a second dispersed phase containing a silicone, wherein the silicone is provided from a water continuous silicone emulsion containing at least one surfactant; with at least one fabric care ingredient (F) selected from a cationic conditioning agent, a nonionic conditioning agent, a hydrophobic conditioning agent, and mixtures thereof, optionally in the presence of an acceptable medium, to form a mixture; and
applying the mixture to the fabric substrates and fibres; and
optionally letting the mixture stand on the fabric substrates and fibres; and/or
optionally rinsing the fabric substrates and fibres

11. (canceled)

12. The fabric care composition of claim 1, where the acceptable medium is present.

13. The fabric care composition of claim 2, where the dispersed phase containing a silicone is selected from a “macro” emulsion or a “micro” emulsion.

14. The fabric care composition of claim 2, where the hydrophobic oil of the first dispersed phase comprises the organic oil, with the organic oil selected from the group of hydrocarbons, esters, oils derived from natural fats or natural oils, organic polymers, or mixtures thereof.

15. The fabric care composition of claim 2, where the hydrophobic oil of the first dispersed phase comprises the silicone.

16. A process of caring for a fabric substrate, the process comprising the step of applying a fabric care composition to the fabric substrate, wherein the fabric care composition is as set forth in claim 1.
